(19) United States
(12) Patent Application Publication
(10) Pub. No.: US 2002/0191695 A1
(43) Pub. Date: Dec. 19, 2002

(54) Interframe encoding method and apparatus

(76) Inventors: Ann Chris Irvine, Bonsoll, CA (US); Vijayalakshmi R. Raveendran, San Diego, CA (US)

Correspondence Address: QUALCOMM Incorporated, Attn: Patent Department, 5775 Morehouse Drive, San Diego, CA, 92121-1714, US

(21) Appl. No.: 09/877,578

(22) Filed: Jun. 7, 2001

(51) Int. Cl. H04N 7/12

(52) U.S. Cl. 375/240.03; 375/240.2; 375/240.24; 375/240.23

(57) ABSTRACT

In a system for encoding digital video, a method of interframe coding is described. A sequence of digital video frames may be expressed as anchor frames and at least one associated subsequent frame. The plurality of pixels of the anchor frame and each subsequent frame are converted from pixel domain elements to the frequency domain elements. The elements are quantized to emphasize those elements that are more sensitive to the human visual system and de-emphasize those elements that are less sensitive to the human visual system. The difference between each quantized frequency domain element of the anchor frame and corresponding quantized frequency domain elements of each subsequent frame are determined and encoded.

### BACKGROUND OF THE INVENTION

I. Field of the Invention

The present invention relates to digital signal processing. More specifically, the present invention relates to a loss-less method of encoding digital image information.

II. Description of the Related Art

Digital picture processing has a prominent position in the general discipline of digital signal processing. The importance of human visual perception has encouraged tremendous interest and advances in the art and science of digital picture processing. In the field of transmission and reception of video signals, such as those used for projecting films or movies, various improvements are being made to image compression techniques. Many of the current and proposed video systems make use of digital encoding techniques. Aspects of this field include image coding, image restoration, and image feature selection. Image coding represents the attempts to transmit pictures of digital communication channels in an efficient manner, making use of as few bits as possible to minimize the band width required, while at the same time, maintaining distortions within certain limits. Image restoration represents efforts to recover the true image of the object. The coded image being transmitted over a communication channel may have been distorted by various factors. Source of degradation may have arisen originally in creating the image from the object. Feature selection refers to the selection of certain attributes of the picture. Such attributes may be required in the recognition, classification, and decision in a wider context.

Digital encoding of video, such as that in digital cinema, is an area which benefits from improved image compression techniques. Digital image compression may be generally classified into two categories: loss-less and lossy methods. A loss-less image is recovered without any loss of information. A lossy method involves an irrecoverable loss of some information, depending upon the compression ratio, the quality of the compression algorithm, and the implementation of the algorithm. Generally, lossy compression approaches are considered to obtain the compression ratios desired for a cost-effective digital cinema approach. To achieve digital cinema quality levels, the compression approach should provide a visually loss-less level of performance. As such, although there is a mathematical loss of information as a result of the compression process, the image distortion caused by this loss should be imperceptible to a viewer under normal viewing conditions.

Existing digital image compression technologies have been developed for other applications, namely for television systems. Such technologies have made design compromises appropriate for the intended application, but do not meet the quality requirements needed for cinema presentation.

Digital cinema compression technology should provide the visual quality that a moviegoer has previously experienced. Ideally, the visual quality of digital cinema should attempt to exceed that of a high-quality release print film. At the same time, the compression technique should have high coding efficiency to be practical. As defined herein, coding efficiency refers to the bit rate needed for the compressed image quality to meet a certain qualitative level.

Video compression techniques are typically based on differential pulse code modulation (DPCM), discrete cosine transform (DCT), motion compensation (MC), entropy coding, fractual compression, and wavelet transform. One compression technique capable of offering significant levels of compression while preserving the desired level of quality for video signals utilizes adaptively sized blocks and sub-blocks of encoded DCT coefficient data. This technique will hereinafter be referred to as the Adaptive Block Size Differential Cosine Transform (ABSDCT) method.

A key aspect of video compression is similarity between adjacent frames in a sequence. A predominant existing art in this domain is motion compensation, as in MPEG. Motion compensation is done by coding images using imperfect prediction from adjacent frames in a sequence. Such prediction and/or compensation schemes introduce errors between the original source and decoded video sequences. Often, these errors mount to unacceptable levels and introduce objectionable matter in high image quality applications. For example, motion artifacts are frequently visible in Motion Picture Experts Group (MPEG) compressed material. Motion artifacts refer to being able to see the effect of a previous or future frame on a current frame, or hosting. Such motion artifacts also make video editing on a frame by frame basis a difficult task. Thus, what is needed is an interframe encoding scheme that overcomes the disadvantages of current interframe encoding techniques, and minimizes visible deficiencies such as motion artifacts.

### SUMMARY OF THE INVENTION

Embodiments of the invention exploit interframe coding methodologies which efficiently increase the compression gain offered by any transform based compression technique and do not introduce any additional distortion. Such methodologies, referred to herein as a delta coder or delta coding processing, exploit spatial and temporal redundancy in video sequences in the frequency domain. That is, the delta coder exploits sequences in which there is a high degree of correlation of the temporal domain whenever there is little change from one frame to the next. As such, transform domain characteristics remain remarkably consistent between adjacent frames in a video sequence.

In a system for encoding digital video, a method of interframe coding is described. The digital video comprises an anchor frame and at least one subsequent frame. Each anchor frame and each subsequent frame comprise a plurality of pixel elements. The plurality of pixels of the anchor frame and each subsequent frame are converted from pixel domain elements to the frequency domain elements. The frequency domain elements are quantized to emphasize those elements that are more sensitive to the human visual system and de-emphasize those elements that are less sensitive to the human visual system. The difference between each quantized frequency domain element of the anchor frame and corresponding quantized frequency domain elements of each subsequent frame are determined. In an embodiment, an anchor frame is associated with a predetermined number of subsequent frames. In another embodiment, the anchor frame is associated with subsequent frames until the correlation characteristics between the subsequent frame and the anchor frame reaches an unacceptable level. In yet another embodiment, a rolling anchor frame is utilized.

Accordingly, it is a feature and advantage of the invention to efficiently encode image data.

It is another feature and advantage of the invention to minimize the effects of motion artifacts.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a block diagram of an image processing system that incorporates the variance based block size assignment system and method of the present invention;

FIG. 2 is a flow diagram illustrating the processing steps involved in variance based block size assignment;

FIG. 3 is a flow diagram illustrating the processing steps involved in interframe coding; and

FIG. 4 illustrates a flow diagram illustrating the processing steps involved in operating the delta coder.

### DETAILED DESCRIPTION OF THE PREFERRED EMBODIMENTS

In order to facilitate digital transmission of digital signals and enjoy the corresponding benefits, it is generally necessary to employ some form of signal compression. To achieve high definition in a resulting image, it is also important that the high quality of the image be maintained. Furthermore, computational efficiency is desired for compact hardware implementation, which is important in many applications.

In an embodiment, image compression of the invention is based on discrete cosine transform (DCT) techniques. Generally, an image to be processed in the digital domain would be composed of pixel data divided into an array of non-overlapping blocks, N×N in size. A two-dimensional DCT may be performed on each block. The two-dimensional DCT is defined by the following relationship:

$$X ( k , l ) = \frac{α ( k ) β ( l )}{N} {\sum }_{m = 0}^{N - 1} {\sum }_{n = 0}^{N - 1} x ( m - n ) cos [ \frac{( 2 m + 1 ) π k}{2 N} ] cos [ \frac{( 2 n + 1 ) π l}{2 N} ] , 0 \leq k , l \leq N - 1$$

$$where α ( k ) , β ( k ) = \{ \begin{matrix}1 , & if k = 0 \\ \sqrt{2} , & if k \neq 0\end{matrix} , and$$

x(m,n) is the pixel location (m,n) within an N×M block, and

X(k,l) is the corresponding DCT coefficient.

Since pixel values are non-negative, the DCT component X(0,0) is always positive and usually has the most energy. In fact, for typical images, most of the transform energy is concentrated around the component X(0,0). This energy compaction property makes the DCT technique such an attractive compression method.

It has been observed that most natural images are made up of flat relatively slow varying areas, and busy areas such as object boundaries and high-contrast texture. Contrast adaptive coding schemes take advantage of this factor by assigning more bits to the busy areas and less bits to the less busy areas. This technique is disclosed in U.S. Pat. No. 5,021,891, entitled “Adaptive Block Size Image Compression Method and System,” assigned to the assignee of the present invention and incorporated herein by reference. DCT techniques are also disclosed in U.S. Pat. No. 5,107,345, entitled “Adaptive Block Size Image Compression Method And System,” assigned to the assignee of the present invention and incorporated herein by reference. Further, the use of the ABSDCT technique in combination with a Differential Quadtree Transform technique is discussed in U.S. Pat. No. 5,452,104, entitled “Adaptive Block Size Image Compression Method And System,” also assigned to the assignee of the present invention and incorporated herein by reference. The systems disclosed in these patents utilizes what is referred to as “intra-frame” encoding, where each frame of image data is encoded without regard to the content of any other frame. Using the ABSDCT technique, the achievable data rate may be greatly without discernible degradation of the image quality.

Using ABSDCT, a video signal will generally be segmented into blocks of pixels for processing. For each block, the luminance and chrominance components are passed to a block interleaver. For example, a 16×16 (pixel) block may be presented to the block interleaver, which orders or organizes the image samples within each 16×16 block to produce blocks and composite sub-blocks of data for discrete cosine transform (DCT) analysis. The DCT operator is one method of converting a time-sampled signal to a frequency representation of the same signal. By converting to a frequency representation, the DCT techniques have been shown to allow for very high levels of compression, as quantizers can be designed to take advantage of the frequency distribution characteristics of an image. In a preferred embodiment, one 16×16 DCT is applied to a first ordering, four 8×8 DCTs are applied to a second ordering, 16 4×4 DCTs are applied to a third ordering, and 64 2×2 DCTs are applied to a fourth ordering.

For image processing purposes, the DCT operation is performed on pixel data that is divided into an array of non-overlapping blocks. Note that although block sizes are discussed herein as being N×N in size, it is envisioned that various block sizes may be used. For example, a N×M block size may be utilized where both N and M are integers with M being either greater than or less than N. Another important aspect is that the block is divisible into at least one level of sub-blocks, such as N/ixN/i, N/ixN/j, N/ixM/j, and etc. where i and j are integers. Furthermore, the exemplary block size as discussed herein is a 16×16 pixel block with corresponding block and sub-blocks of DCT coefficients. It is further envisioned that various other integers such as both even or odd integer values may be used, e.g. 9×9.

In general, an image is divided into blocks of pixels for processing. A color signal may be converted from RGB space to YC₁C₂ space, with Y being the luminance, or brightness, component, and C₁ and C₂ being the chrominance, or color, components. Because of the low spatial sensitivity of the eye to color, many systems sub-sample the C₁ and C₂ components by a factor of four in the horizontal and vertical directions. However, the sub-sampling is not necessary. A full resolution image, known as 4:4:4 format, may be either very useful or necessary in some applications such as those referred to as covering “digital cinema.” Two possible YC₁C₂ representations are, the YIQ representation and the YUV representation, both of which are well known in the art. It is also possible to employ a variation of the YUV representation known as YCbCr.

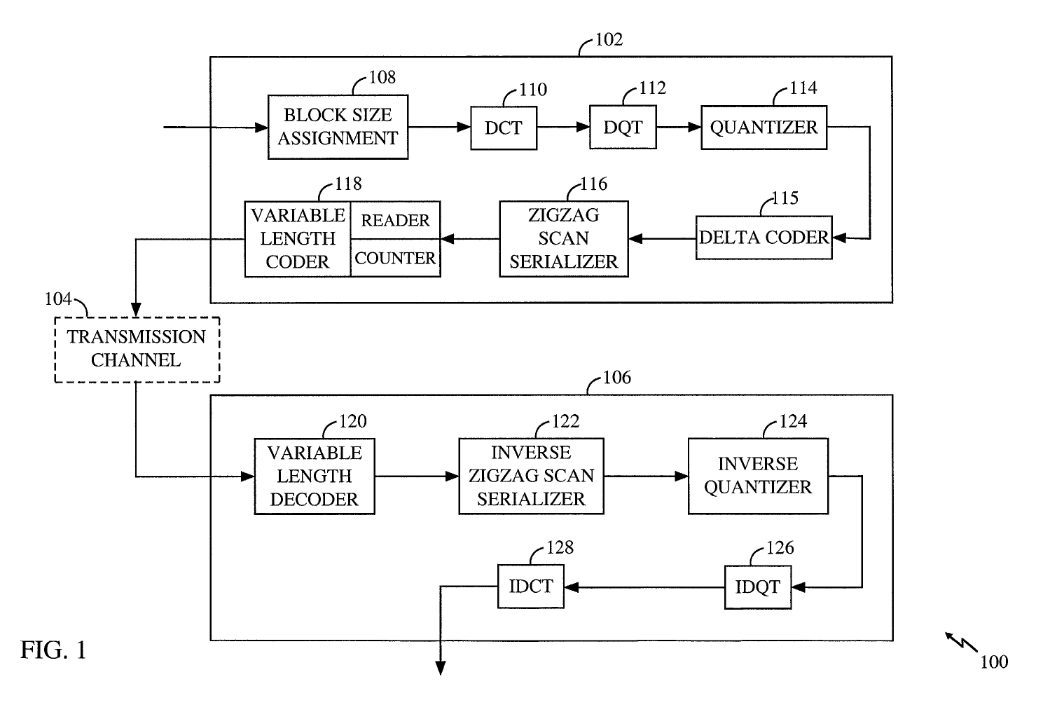

Referring now to FIG. 1, an image processing system 100 which incorporates the invention is shown. The image processing system 100 comprises an encoder 102 that compresses a received video signal. The compressed signal is transmitted or conveyed, through a physical medium, through a transmission channel 104, and received by a decoder 106. The decoder 106 decodes the received signal into image samples, which may then be displayed.

In a preferred embodiment, each of the Y, Cb, and Cr components is processed without sub-sampling. Thus, an input of a 16×16 block of pixels is provided to the encoder 102. The encoder 102 may comprise a block size assignment element 108, which performs block size assignment in preparation for video compression. The block size assignment element 108 determines the block decomposition of the 16×16 block based on the perceptual characteristics of the image in the block. Block size assignment subdivides each 16×16 block into smaller blocks in a quad-tree fashion depending on the activity within a 16×16 block. The block size assignment element 108 generates a quad-tree data, called the PQR data, whose length can be between 1 and 21 bits. Thus, if block size assignment determines that a 16×16 block is to be divided, the R bit of the PQR data is set and is followed by four additional bits of Q data corresponding to the four divided 8×8 blocks. If block size assignment determines that any of the 8×8 blocks is to be subdivided, then four additional bits of P data for each 8×8 block subdivided are added.

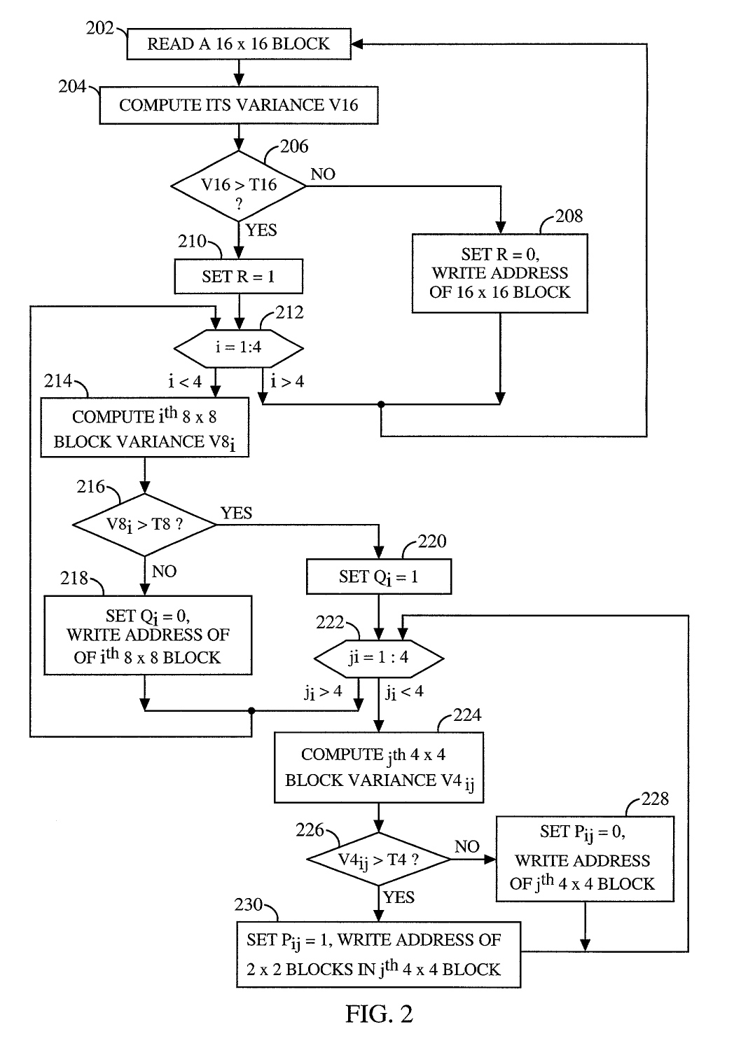

Referring now to FIG. 2, a flow diagram showing details of the operation of the block size assignment element 108 is provided. The algorithm uses the variance of a block as a metric in the decision to subdivide a block. Beginning at step 202, a 16×16 block of pixels is read. At step 204, the variance, v16, of the 16×16 block is computed. The variance is computed as follows:

$$var = \frac{1}{{N}^{2}} {\sum }_{i = 0}^{N - 1} {\sum }_{j = 0}^{N - 1} {x}_{i , j}^{2} - {( \frac{1}{{N}^{2}} {\sum }_{i = 0}^{N - 1} {\sum }_{j = 0}^{N - 1} {x}_{i , j} )}^{2}$$

where N=16, and xᵢⱼ is the pixel in the i^{th} row, j^{th} column within the N×N block. At step 206, first the variance threshold T16 is modified to provide a new threshold T′16 if the mean value of the block is between two predetermined values, then the block variance is compared against the new threshold, T′16.

If the variance v16 is not greater than the threshold T16, then at step 208, the starting address of the 16×16 block is written, and the R bit of the PQR data is set to 0 to indicate that the 16×16 block is not subdivided. The algorithm then reads the next 16×16 block of pixels. If the variance v16 is greater than the threshold T16, then at step 210, the R bit of the PQR data is set to 1 to indicate that the 16×16 block is to be subdivided into four 8×8 blocks.

The four 8×8 blocks, i=1:4, are considered sequentially for further subdivision, as shown in step 212. For each 8×8 block, the variance, v8ᵢ, is computed, at step 214. At step 216, first the variance threshold T8 is modified to provide a new threshold T′8 if the mean value of the block is between two predetermined values, then the block variance is compared to this new threshold.

If the variance v8ᵢ is not greater than the threshold T8, then at step 218, the starting address of the 8×8 block is written, and the corresponding Q bit, Qᵢ, is set to 0. The next 8×8 block is then processed. If the variance v8ᵢ is greater than the threshold T8, then at step 220, the corresponding Q bit, Qᵢ, is set to 1 to indicate that the 8×8 block is to be subdivided into four 4×4 blocks.

The four 4×4 blocks, jᵢ=1:4, are considered sequentially for further subdivision, as shown in step 222. For each 4×4 block, the variance, v4ᵢⱼ, is computed, at step 224. At step 226, first the variance threshold T4 is modified to provide a new threshold T′4 if the mean value of the block is between two predetermined values, then the block variance is compared to this new threshold.

If the variance v4ᵢⱼ is not greater than the threshold T4, then at step 228, the address of the 4×4 block is written, and the corresponding P bit, Pᵢⱼ, is set to 0. The next 4×4 block is then processed. If the variance v⁴ᵢⱼ is greater than the threshold T4, then at step 230, the corresponding P bit, Pᵢⱼ, is set to 1 to indicate that the 4×4 block is to be subdivided into four 2×2 blocks. In addition, the address of the 4 2×2 blocks are written.

The thresholds T16, T8, and T4 may be predetermined constants. This is known as the hard decision. Alternatively, an adaptive or soft decision may be implemented. The soft decision varies the thresholds for the variances depending on the mean pixel value of the 2N×2N blocks, where N can be 8, 4, or 2. Thus, functions of the mean pixel values, may be used as the thresholds.

For purposes of illustration, consider the following example. Let the predetermined variance thresholds for the Y component be 50, 1100, and 880 for the 16×16, 8×8, and 4×4 blocks, respectively. In other words, T16=50, T8=1100, and T16=880. Let the range of mean values be 80 and 100. Suppose the computed variance for the 16×16 block is 60. Since 60 and its mean value 90 is greater than T16, the 16×16 block is subdivided into four 8×8 sub-blocks. Suppose the computed variances for the 8×8 blocks are 1180, 935, 980, and 1210. Since two of the 8×8 blocks have variances that exceed T8, these two blocks are further subdivided to produce a total of eight 4×4 sub-blocks. Finally, suppose the variances of the eight 4×4 blocks are 620, 630, 670, 610, 590, 525, 930, and 690, with the first four corresponding means values 90, 120, 110, 115. Since the mean value of the first 4×4 block falls in the range (80, 100), its threshold will be lowered to T4=200 which is less than 880. So, this 4×4 block will be subdivided as well as the seventh 4×4 block.

Note that a similar procedure is used to assign block sizes for the color components C₁ and C₂. The color components may be decimated horizontally, vertically, or both. Additionally, note that although block size assignment has been described as a top down approach, in which the largest block (16×16 in the present example) is evaluated first, a bottom up approach may instead be used. The bottom up approach will evaluate the smallest blocks (2×2 in the present example) first.

Referring back to FIG. 1, the remainder of the image processing system 110 will be described. The PQR data, along with the addresses of the selected blocks, are provided to a DCT element 110. The DCT element 110 uses the PQR data to perform discrete cosine transforms of the appropriate sizes on the selected blocks. Only the selected blocks need to undergo DCT processing.

The image processing system 100 may optionally comprise DQT element 112 for reducing the redundancy among the DC coefficients of the DCTs. A DC coefficient is encountered at the top left corner of each DCT block. The DC coefficients are, in general, large compared to the AC coefficients. The discrepancy in sizes makes it difficult to design an efficient variable length coder. Accordingly, it is advantageous to reduce the redundancy among the DC coefficients.

The DQT element 112 performs 2-D DCTs on the DC coefficients, taken 2×2 at a time. Starting with 2×2 blocks within 4×4 blocks, a 2-D DCT is performed on the four DC coefficients. This 2×2 DCT is called the differential quad-tree transform, or DQT, of the four DC coefficients. Next, the DC coefficient of the DQT along with the three neighboring DC coefficients with an 8×8 block are used to compute the next level DQT. Finally, the DC coefficients of the four 8×8 blocks within a 16×16 block are used to compute the DQT. Thus, in a 16×16 block, there is one true DC coefficient and the rest are AC coefficients corresponding to the DCT and DQT.

The transform coefficients (both DCT and DQT) are provided to a quantizer 114 for quantization. In a preferred embodiment, the DCT coefficients are quantized using frequency weighting masks (FWMs) and a quantization scale factor. A FWM is a table of frequency weights of the same dimensions as the block of input DCT coefficients. The frequency weights apply different weights to the different DCT coefficients. The weights are designed to emphasize the input samples having frequency content that the human visual system is more sensitive to, and to de-emphasize samples having frequency content that the visual system is less sensitive to. The weights may also be designed based on factors such as viewing distances, etc.

Huffman codes are designed from either the measured or theoretical statistics of an image. It has been observed that most natural images are made up of blank or relatively slowly varying areas, and busy areas such as object boundaries and high-contrast texture. Huffman coders with frequency-domain transforms such as the DCT exploit these features by assigning more bits to the busy areas and fewer bits to the blank areas. In general, Huffman coders make use of look-up tables to code the run-length and the non-zero values.

The weights are selected based on empirical data. A method for designing the weighting masks for 8×8 DCT coefficients is disclosed in ISO/IEC JTC1 CD 10918, “Digital compression and encoding of continuous-tone still images—part 1:

Requirements and guidelines,” International Standards Organization, 1994, which is herein incorporated by reference. In general, two FWMs are designed, one for the luminance component and one for the chrominance components. The FWM tables for block sizes 2×2, 4×4 are obtained by decimation and 16×16 by interpolation of that for the 8×8 block. The scale factor controls the quality and bit rate of the quantized coefficients.

Thus, each DCT coefficient is quantized according to the relationship:

$${DCT}_{q} ( i , j ) = ⌊ \frac{8 * DCT ( i , j )}{fwm ( i , j ) * q} \pm \frac{1}{2} ⌋$$

where DCT(i,j) is the input DCT coefficient, fwm(i,j) is the frequency weighting mask, q is the scale factor, and DCTq(i,j) is the quantized coefficient. Note that depending on the sign of the DCT coefficient, the first term inside the braces is rounded up or down. The DQT coefficients are also quantized using a suitable weighting mask. However, multiple tables or masks can be used, and applied to each of the Y, Cb, and Cr components.

The quantized coefficients are provided to a delta coder 115. Delta coder 115 efficiently increases the compression gain offered by any transform based compression technique, such as the DCT or the ABSDCT, in a manner that does not add any additional distortion or quantization noise. Delta coder 115 is configured to determine the coefficient differentials form non-zero coefficients across adjacent frames and encodes the differential information losslessly. In another embodiment, the differential information may be encoded slightly lossy. Such an embodiment may be desirable in balancing quality considerations with space and/or speed requirements.

The delta coded coefficients of anchor frames and corresponding subsequent frames are provided to a zigzag scan serializer 116. The serializer 116 scans the blocks of quantized coefficients in a zigzag fashion to produce a serialized stream of quantized coefficients. A number of different zigzag scanning patterns, as well as patterns other than zigzag may also be chosen. An embodiment employs 8×8 block sizes for the zigzag scanning, although other sizes such as 32×32, 16×16, 4×4, 2×2 or combinations thereof may be employed.

Note that the zigzag scan serializer 116 may be placed either before or after the quantizer 114. The net results are the same.

In any case, the stream of quantized coefficients is provided to a variable length coder 118. The variable length coder 118 may make use of run-length encoding of zeros followed by encoding. This technique is discussed in detail in aforementioned U.S. Pat. Nos. 5,021,891, 5,107,345, and 5,452,104, and is summarized herein. A run-length coder takes the quantized coefficients and notes the run of successive coefficients from the non-successive coefficients. The successive values are referred to as run-length values, and are encoded. The non-successive values are separately encoded. In an embodiment, the successive coefficients are zero values, and the non-successive coefficients are non-zero values. Typically, the run length is from 0 to 63 bits, and the size is an AC value from 1-10. An end of file code adds an additional code—thus, there is a total of 641 possible codes.

The compressed image signal generated by the encoder 102 is transmitted to the decoder 106 via the transmission channel 104. The PQR data, which contains the block size assignment information, is also provided to the decoder 106. The decoder 106 comprises a variable length decoder 120, which decodes the run-length values and the non-zero values.

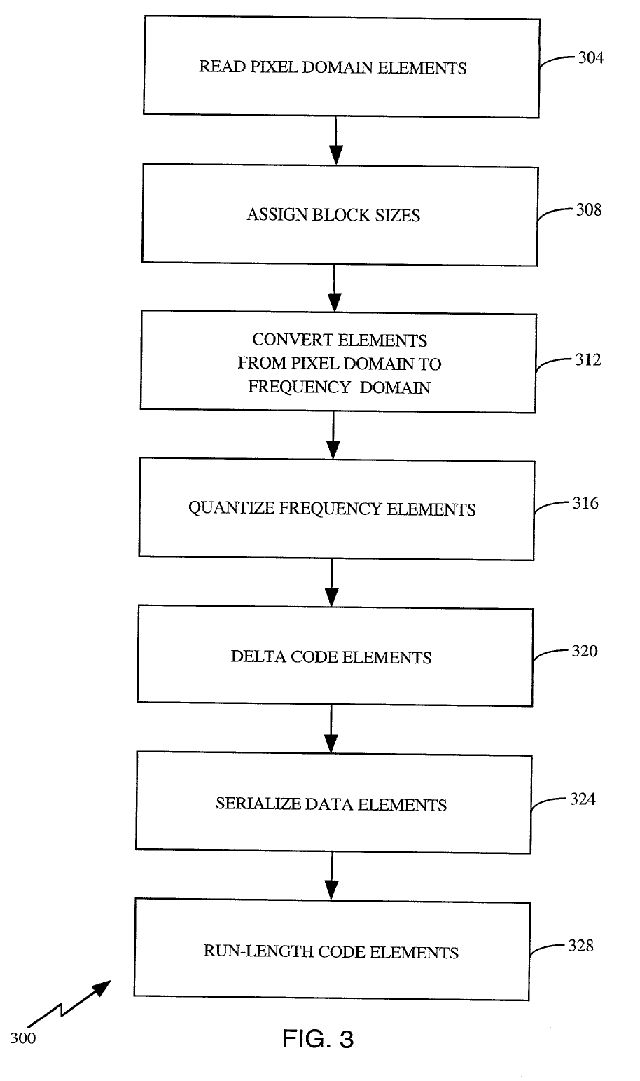

Frequency domain method, such as the DCT, transforms a block of pixels into a new block of less correlated and fewer transformed coefficients. Such frequency domain compression schemes also use knowledge of distortions perceived in images to improve this objective performance of the encoding scheme. FIG. 3 illustrates such a process of an interframe coder 300. Encoded frame data is initially read 304 into the system in the pixel domain. Each frame of encoded data is then divided 308 into pixel blocks. In an embodiment, block sizes are variable and assigned using an adaptive block size discrete cosine transform (ABSDCT) technique. Block sizes vary based on the amount of detail within a given area. Any block sizes may be used, such as 2×2, 4×4, 8×8, 16×16 or 32×32.

The encoded data then undergoes a process to convert 312 from the pixel domain to elements in the frequency domain. This involves DCT and DQT processing, as described in FIG. 2. DCT/DQT processing is also described in pending U.S. Patent Application entitled “APPARATUS AND METHOD FOR COMPUTING A DISCRETE COSINE TRANSFORM USING A BUTTERFLY PROCESSOR”, Ser. No. UNKNOWN, filed Jun. 6, 2001, Attorney Docket No. 990437, which is specifically incorporated by reference herein.

The encoded frequency domain elements are then quantized 316. Quantization may involve frequency weighting in accordance with contrast sensitivity followed by coefficient quantization. Resulting blocks of encoded data in the frequency domain have far fewer non-zero coefficients to encode. The corresponding blocks of encoded data in the frequency domain in adjacent frames typically have similar characteristics in terms of location and pattern of zeros and magnitudes of coefficients. The quantized frequency elements are then delta coded 320. The delta coder computes the coefficient differentials for non-zero coefficients across adjacent frames and encodes the information losslessly. Encoding the information losslessly is accomplished by serialization 324 and run length amplitude coding 328. In an embodiment, the run length amplitude coding is followed by entropy coding such as Huffman coding. The serialization process 324 may be extended across frames of interest to achieve longer run lengths, thereby further increasing the efficiency of the delta coder. In an embodiment, zig-zag ordering is also utilized.

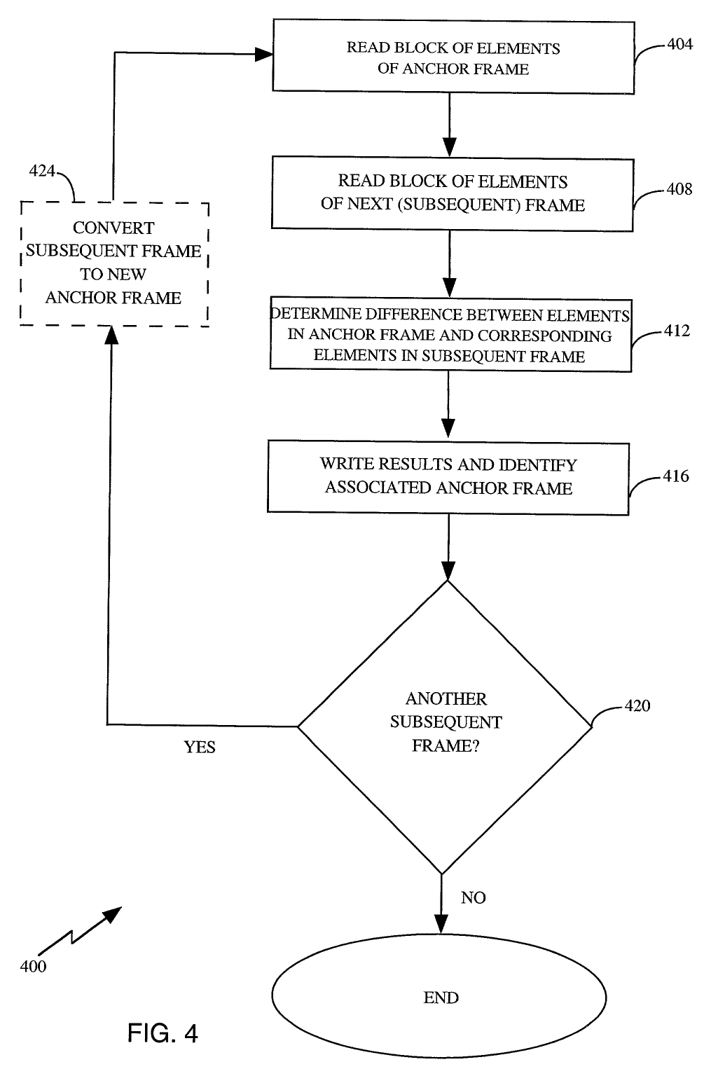

FIG. 4 illustrates operation of a delta coder 400. A plurality of adjacent frames may be viewed as a first frame, or anchor frame, and corresponding adjacent frames, or subsequent frames. First, a block of elements in the frequency domain of the anchor frame is input 404. Corresponding block of elements from the next, or subsequent, frame are also read in 408. In an embodiment, block sizes of 16×16 are used regardless of the breakdown of the block size by the BSA. It is contemplated, however, that any block size could be used.

In an embodiment, variable block sizes as defined by the BSA may be used. The difference between corresponding elements of the anchor frame and the subsequent frame is determined 412. In an embodiment, only the corresponding AC values of blocks in the anchor frame and each subsequent frame are compared. In another embodiment, both the DC values and the AC values are compared. Thus, the subsequent frame may be expressed as the results of the difference between the anchor frame and the subsequent frame 416, as long as the difference is associated with the appropriate anchor frame. Processing block by block, all the corresponding elements of the anchor frame and the subsequent frame are compared and the differences are computed. Then, an inquiry 420 is made as to whether there is another subsequent frame. If so, the anchor frame is compared with the next subsequent frame in the same manner. This process is repeated until the anchor frame and all associated subsequent frames are computed.

In an embodiment, an anchor frame is associated with four subsequent frames, although it is contemplated that any number of frames may be used. In another embodiment, an anchor frame is associated with N subsequent frames, where N is dependent on the correlation characteristics of the image sequence. In other words, once the computed differences between an anchor frame and a given subsequent frame cross a particular threshold, a new anchor frame is established. In an embodiment, the threshold is predetermined. It has been found that a correlation between frames of about 95% balances quality considerations while maintaining an acceptable bit rate. This, however, may vary based on the underlying material. In another embodiment, the threshold is configurable to any correlation level.

In yet another embodiment, a rolling anchor frame is utilized. Upon calculation of the first subsequent frame, the subsequent frame becomes the new anchor frame 424 and a comparison of that frame with its adjacent frame is performed. As such, upon determination of the differences between an anchor frame and a subsequent frame, a subsequent frame becomes the new anchor frame to be compared against. For example, if frame 1 is the anchor frame, and frame 2 is a subsequent frame, the difference between frame 1 and frame 2 is determined in the manner described above. Frame 2 becomes the new anchor frame by which frame 3 is compared against, and the differences between corresponding elements are again computed. This process is repeated through all the frames of the material.

The compression encoding algorithms and methodologies in aspects of embodiments may be contained in many compression and digital video processing schemes. Embodiments of the invention may reside on a computer or customized applications specific integrated circuit performing compression and encoding of digital video. The algorithm itself may be implemented in software or in programmable or custom hardware.

Referring back to FIG. 1, the output of the variable length decoder 120 is provided to an inverse zigzag scan serializer 122 that orders the coefficients according to the scan scheme employed. The inverse zigzag scan serializer 122 receives the PQR data to assist in proper ordering of the coefficients into a composite coefficient block.

The composite block is provided to an inverse quantizer 124, for undoing the processing due to the use of the frequency weighting masks. The resulting coefficient block is then provided to an IDQT element 126, followed by an IDCT element 128, if the Differential Quad-tree transform had been applied. Otherwise, the coefficient block is provided directly to the IDCT element 128. The IDQT element 126 and the IDCT element 128 inverse transform the coefficients to produce a block of pixel data. The pixel data may be then have to be interpolated, converted to RGB form, and then stored for future display.

As examples, the various illustrative logical blocks, flowcharts, and steps described in connection with the embodiments disclosed herein may be implemented or performed in hardware or software with an application-specific integrated circuit (ASIC), a programmable logic device, discrete gate or transistor logic, discrete hardware components, such as, e.g., registers and FIFO, a processor executing a set of firmware instructions, any conventional programmable software and a processor, or any combination thereof. The processor may advantageously be a microprocessor, but in the alternative, the processor may be any conventional processor, controller, microcontroller, or state machine. The software could reside in RAM memory, flash memory, ROM memory, registers, hard disk, a removable disk, a CD-ROM, a DVD-ROM or any other form of storage medium known in the art.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What we claim as our invention is:

1. In a system for encoding digital video, the digital video comprising an anchor frame and at least one subsequent frame, the anchor frame and each subsequent frame comprising a plurality of pixel elements, a method of interframe coding, the method comprising:
converting the plurality of pixels of the anchor frame and each subsequent frame from pixel domain elements to the frequency domain elements, the frequency domain elements capable of being represented as DC elements and AC elements;
quantizing the frequency domain elements to emphasize those elements that are more sensitive to the human visual system and de-emphasize those elements that are less sensitive to the human visual system; and
determining the difference between each quantized frequency domain element of the anchor frame and corresponding quantized frequency domain elements of each subsequent frame.

2. The method as set forth in claim 1, wherein the act of converting utilizes discrete cosine transforms (DCT).

3. The method as set forth in claim 2, wherein the act of converting further utilizes discrete quadtree transforms (DQT).

4. The method as set forth in claim 1, wherein the act of quantizing further comprises weighting the elements using a frequency weighted mask.

5. The method as set forth in claim 4, wherein the act of quantizing further comprises utilizing a quantizer step function.

6. The method as set forth in claim 1, wherein four subsequent frames are compared against the anchor frame.

7. The method as set forth in claim 1, wherein only the difference between AC quantized frequency domain elements is determined.

8. The method as set forth in claim 1, further comprising grouping the plurality of pixel elements into 16×16 block sizes.

9. The method as set forth in claim 1, wherein the act of quantizing results in lossless frequency domain elements.

10. The method as set forth in claim 9, wherein act of quantizing results in lossy frequency domain elements.

11. The method as set forth in claim 1, further comprising expressing the subsequent frame as the difference between quantized frequency domain elements of the anchor frame and corresponding frequency domain elements of the subsequent frame.

12. The method as set forth in claim 1, further comprising serializing the quantized frequency domain elements.

13. The method as set forth in claim 12, further comprising variable length coding the serialized quantized frequency domain elements.

14. In a system for encoding digital video, the digital video comprising a plurality of frames 1, 2, 3, . . . , N, each frame comprising a plurality of pixel elements, a method of interframe coding, the method comprising:
converting the plurality of pixels of each frame from pixel elements to the frequency domain elements, the frequency domain elements capable of being represented in rows and columns;
quantizing the frequency domain elements to demphasize those elements that are more sensitive to the human visual system and de-emphasize those elements that are less sensitive to the human visual system; and
determining the difference between the quantized frequency domain element of the first frame and corresponding quantized frequency domain elements of the second frame; and
repeating the process of determining the difference between quantized frequency domain elements of successive frames such that quantized frequency domain elements of each frame are compared against quantized frequency domain elements of the frame immediately preceeding it.

15. The method as set forth in claim 14, further comprising expressing each frame 2 through N as the difference between quantized frequency domain elements of frames 2 through N and corresponding frequency domain elements of the frames 1 through N-1, respectively.

16. The method as set forth in claim 14, wherein the act of converting utilizes discrete cosine transforms (DCT).

17. The method as set forth in claim 16, wherein the act of converting further utilizes discrete quadtree transforms (DQT).

18. The method as set forth in claim 14, wherein the act of quantizing further comprises weighting the elements using a frequency weighted mask.

19. The method as set forth in claim 18, wherein the act of quantizing further comprises utilizing a quantizer step function.

20. The method as set forth in claim 14, wherein only the difference between AC quantized frequency domain elements is determined.

21. The method as set forth in claim 14, further comprising grouping the plurality of pixel elements into 16×16 block sizes.

22. The method as set forth in claim 14, wherein the act of determining results in lossless frequency domain elements.

23. The method as set forth in claim 14, wherein act of determining results in lossy frequency domain elements.

24. The method as set forth in claim 14, further comprising expressing the subsequent frame as the difference between quantized frequency domain elements of the anchor frame and corresponding frequency domain elements of the subsequent frame.

25. The method as set forth in claim 14, further comprising serializing the quantized frequency domain elements.

26. The method as set forth in claim 25, further comprising variable length coding the serialized quantized frequency domain elements.

27. The method as set forth in claim 26, wherein the variable length encoded serialized quantized frequency domain elements are Huffman encoded.

28. In a system for encoding digital video, the digital video comprising an anchor frame and at least one subsequent frame, the anchor frame and each subsequent frame comprising a plurality of pixel elements, an apparatus configured for interframe coding, the method comprising:
means for converting the plurality of pixels of the anchor frame and each subsequent frame from pixel domain elements to the frequency domain elements, the frequency domain elements capable of being represented as DC elements and AC elements;
means for quantizing the frequency domain elements to emphasize those elements that are more sensitive to the human visual system and de-emphasize those elements that are less sensitive to the human visual system; and
means for determining the difference between each quantized frequency domain element of the anchor frame and corresponding quantized frequency domain elements of each subsequent frame.

29. The apparatus as set forth in claim 28, wherein the means for converting utilizes discrete cosine transforms (DCT).

30. The apparatus as set forth in claim 29, wherein the means for converting further utilizes discrete quadtree transforms (DQT).

31. The apparatus as set forth in claim 28, wherein the means for quantizing further comprises weighting the elements using a frequency weighted mask.

32. The apparatus as set forth in claim 31, wherein the means for quantizing further comprises utilizing a quantizer step function.

33. The apparatus as set forth in claim 28, wherein four subsequent frames are compared against the anchor frame.

34. The apparatus as set forth in claim 28, wherein the means for determining only determines the difference between AC quantized frequency domain elements is determined.

35. The apparatus as set forth in claim 28, further comprising means for grouping the plurality of pixel elements into 16×16 block sizes.

36. The apparatus as set forth in claim 28, wherein the means for quantizing results in lossless frequency domain elements.

37. The apparatus as set forth in claim 36, wherein the means for quantizing results in lossy frequency domain elements.

38. The apparatus as set forth in claim 28, further comprising means for expressing the subsequent frame as the difference between quantized frequency domain elements of the anchor frame and corresponding frequency domain elements of the subsequent frame.

39. The apparatus as set forth in claim 28, further comprising means for serializing the quantized frequency domain elements.

40. The method as set forth in claim 39, further comprising means for variable length coding the serialized quantized frequency domain elements.

41. In a system for encoding digital video, the digital video comprising a plurality of frames 1, 2, 3, . . . , N, each frame comprising a plurality of pixel elements, a method of interframe coding, the apparatus comprising:
means for converting the plurality of pixels of each frame from pixel elements to the frequency domain elements, the frequency domain elements capable of being represented in rows and columns;
means for quantizing the frequency domain elements to demphasize those elements that are more sensitive to the human visual system and de-emphasize those elements that are less sensitive to the human visual system; and
means for determining the difference between the quantized frequency domain element of the first frame and corresponding quantized frequency domain elements of the second frame; and
means for repeating the process of determining the difference between quantized frequency domain elements of successive frames such that quantized frequency domain elements of each frame are compared against quantized frequency domain elements of the frame immediately preceeding it.

42. The apparatus as set forth in claim 41, further comprising means for expressing each frame 2 through N as the difference between quantized frequency domain elements of frames 2 through N and corresponding frequency domain elements of the frames 1 through N-1, respectively.

43. The apparatus as set forth in claim 41, further comprising means for expressing the subsequent frame as the difference between quantized frequency domain elements of the anchor frame and corresponding frequency domain elements of the subsequent frame.

44. In a system for encoding digital video, the digital video comprising a plurality of frames 1, 2, 3, . . . , N, each frame comprising a plurality of pixel elements, a method of interframe coding, the apparatus comprising:
a DCT/DQT transformer configured to convert the plurality of pixels of each frame from pixel elements to the frequency domain elements, the frequency domain elements capable of being represented in rows and columns;
a quantizer connected to the transformer configured to quantize the frequency domain elements to demphasize those elements that are more sensitive to the human visual system and de-emphasize those elements that are less sensitive to the human visual system; and
a delta coder connected to the quantizer configured to determine the difference between the quantized frequency domain element of the first frame and corresponding quantized frequency domain elements of the second frame, and repeating the process of determining the difference between quantized frequency domain elements of successive frames such that quantized frequency domain elements of each frame are compared against quantized frequency domain elements of the frame immediately preceeding it.

45. The apparatus as set forth in claim 44, wherein only the difference between AC quantized frequency domain elements is determined.

46. The apparatus as set forth in claim 44, further comprising a block size assignment configured to group the plurality of pixel elements into variable block sizes.

47. The apparatus as set forth in claim 44, wherein the delta coder produces lossless frequency domain elements.

48. The apparatus as set forth in claim 44, wherein delta coder produces lossy frequency domain elements.

49. The apparatus as set forth in claim 44, further comprising a serializer connected to the quantizer configured to receive the quantized frequency domain elements and resequence the quantized frequency domain elements.

50. The method as set forth in claim 49, further comprising a variable length coder connected to the serializer configured to variable length encode the quantized frequency domain elements.
